(19) United States
(12) Patent Application Publication
(10) Pub. No.: US 2002/0176518 A1
(43) Pub. Date: Nov. 28, 2002

(54) Recovery of high speed, high bit error rate data

(76) Inventor: Yufeng Xu, Kanata (CA)

Correspondence Address: NORTEL NETWORKS LIMITED, P. O. BOX 3511, STATION C, OTTAWA, ON, K1Y 4H7, CA

(21) Appl. No.: 09/864,324

(22) Filed: May 25, 2001

(51) Int. Cl. H04L 25/10; H04L 25/06

(52) U.S. Cl. 375/317; 375/319

(57) ABSTRACT

A binary data signal of a very high speed rate travelling over a transport network is regenerated using two threshold levels. The first threshold, or the preset threshold is initially set by the performance monitor, and thereafter adjusted based on the current quality of the signal eye. The second threshold, or the decision threshold, is determined by the performance monitor based on the preset threshold and on the provisioned BER.

### BACKGROUND OF THE INVENTION

1. Field of the Invention

The invention is directed to signal regeneration in communication networks, and in particular to a system for recovery of high speed, high bit error rate (BER) data.

2. Background Art

The system reach, or the distance between the transmitter and receiver sites, is limited by the dispersion and attenuation of the signal along the transmission medium. In wavelength division multiplexed systems, a plurality of optical carriers (transmission channels), each carrying a signal of a certain rate, travel along the same fiber. The noise imposed over the signals by the transmission medium and by the copropagating channels limits the spacing between the transmitter and the regenerating equipment to approximately 100 km. The dispersion and attenuation limits can be extended beyond this distance using various modulation techniques, new types of non-dispersion optical fiber, optical amplifier technology and other techniques.

The system reach is also limited by the receiver sensitivity. The receiver's task is to decide which symbol was actually transmitted. Detection errors may develop as a result of an incorrect decision level or incorrect clock/data timing being selected. Receiver's “decision level”, also called “decision threshold”, “slicing level”, “sampling level”, decides which values of the regenerated signal are to be considered “logical 1”. For example, a threshold level variation of only 8% can result in a variation of the receiver sensitivity of up to about 1 dB.

The degradation of a signal is expressed by BER (bit error rate), which is the ratio between the number of erroneous bits counted at a receiver site over the total number of bits received.

In the last decade, transmission rates of data signals have increased very fast. For high rate transmission, such as at 40 Gb/s and more, signal corruption introduced by the transmission channel is a critical parameter. Also, the trend is to extend the system reach for reducing the cost of regenerators and optical amplifiers to the network providers. Therefore, the demand for receivers with high sensitivity increased progressively with the transmission rates.

Current optical receivers comprise an avalanche photodiode (APD), or a high performance PIN photodiode, coupled to a transimpedance amplifier. The transimpedance amplifier is a shunt feedback amplifier acting as a current-to-voltage transducer. The signal is then amplified and a data regenerator extracts the information from the amplified signal. Generally, binary data regenerators are provided with a fixed threshold level selected such as to provide the best error rate at a predetermined signal power level. However, a fixed threshold cannot account for the effects of aging of the components, temperature variations, etc. As a result, higher power levels need to be transmitted to account for the above factors, which in turn diminish the system reach.

As the requirement for essentially error free operation for fiber systems became more stringent, systems which allowed errors to occur during the normal data regeneration mode of operation are currently less acceptable. Driven by customer demand, sophisticated performance monitors are provided at the receiver site, which perform optimization routines for lowering the BER of the recovered signal.

It is known to generate a control code at the transmission site which is then transmitted with the information along the communication link. This control code travels along with the information signal and suffers similar degradation. Error detection is based in general on comparison between the transmitted and the received control code. Error correction is based on various algorithms which compensate for the specific error detected in the control code. This method is known as forward error correction (FEC).

A data regenerator including a performance monitor is disclosed in U.S. Pat. No. 4,097,697, issued on Jun. 27, 1978, entitled “Digital Signal Performance Monitor” (Harman, issued on Jun. 27, 1978 and assigned to the Applicants). This patent discloses a first differential amplifier which regenerates the data signal by comparing the incoming signal with a fixed threshold. A second differential amplifier compares the incoming signal with an offset slicing level to produce an error-ed regenerated signal. Both differential amplifiers are clocked by the recovered clock signal. The regenerated signals are compared to each other and the result is used to determine the degradation of the incoming signal.

U.S. Pat. No. 4,823,360 (Tremblay et al., issued Apr. 18, 1989 and assigned to the Applicants), entitled “Binary Data Regenerator With Adaptive Threshold Level” discloses a device for measuring chromatic dispersion of an optical signal, using the eye closure diagram of the signal. The device described in this U.S. patent evaluates the transmission link performance using two or three threshold levels for recovering data. Two of the thresholds are obtained by measuring the level of “long 0s” and “long 1s” on the eye diagram, for a preset error rate. The third threshold is provided in a selected relationship to the other two to produce regenerated signals.

The technique described in the '360 patent is based on generating “pseudo-errors” on separate pseudo-error channels. The pseudo-errors give some idea of how error performance varies with the slicing level and, because they do not appear on the in-service transmission path, they do not affect service. Consequently, this technique can be used for dynamic control of in-service systems. However, the patent does address the problem of how the optimum threshold is set at the beginning of the reception. It is rather assumed that initially the eye of the received signal is “open”, which is not the case in long reach, very high speed (over 10 GB/s per channel) and high density (dense WDM, with e.g. 160 channels) systems.

### SUMMARY OF THE INVENTION

It is an object of the present invention to provide a receiver with means for detection and correction of errors which overcomes totally or in part the deficiencies of the prior art receivers.

It is another object of this invention to provide a smart receiver design, wherein the decision threshold is optimised for low signal-to-noise ratio (SNR) situations.

According to one aspect of the invention, there is provided a device for determining an optimized decision threshold for a high speed, high rate data regenerator, comprising, a first comparator and a first retiming circuit for comparing a recovered data signal with a preset threshold and providing a pseudo-data signal representative of said recovered data signal, a second comparator and a second retiming circuit for comparing said recovered data signal with said optimized decision threshold and providing a regenerated data signal, and a low pass filter for separating a DC component from said first signal and using said DC component to provide said optimized decision threshold.

According to another aspect of the invention, there is provided a method for determining an optimized decision threshold for a high speed, high rate data regenerator, comprising, comparing and retiming a recovered data signal with a preset threshold, for providing a pseudo-data signal representative of said recovered data signal, comparing and retiming said recovered data signal with said optimized decision threshold for providing a regenerated data signal, filtering said pseudo-data signal for separating a DC component, and monitoring said DC component to provide said optimized decision threshold.

Advantageously, the invention provides a simplified design for a high speed decision circuit which delivers a substantially error-free output, despite the fact that there are errors occurring on the data channel.

The detector according to the invention works at low signal-to-noise (SNR) ratio and can thus significantly increase the tolerable operation range of a high-capacity, long-haul optical transport system.

### BRIEF DESCRIPTION OF THE DRAWINGS

The foregoing and other objects, features and advantages of the invention will be apparent from the following more particular description of the preferred embodiments, as illustrated in the appended drawings, where:

FIG. 1A shows the block diagram of a decoder used currently for recovering data;

FIG. 1B illustrates schematically an eye diagram;

FIG. 2 shows the block diagram of the decoder of FIG. 1, with the changes according to the present invention; and

FIGS. 3A, 3B, and 3C show Voltage-Time diagrams in various points of the eye diagram of FIG. 1B.

### DESCRIPTION OF THE PREFERRED EMBODIMENT

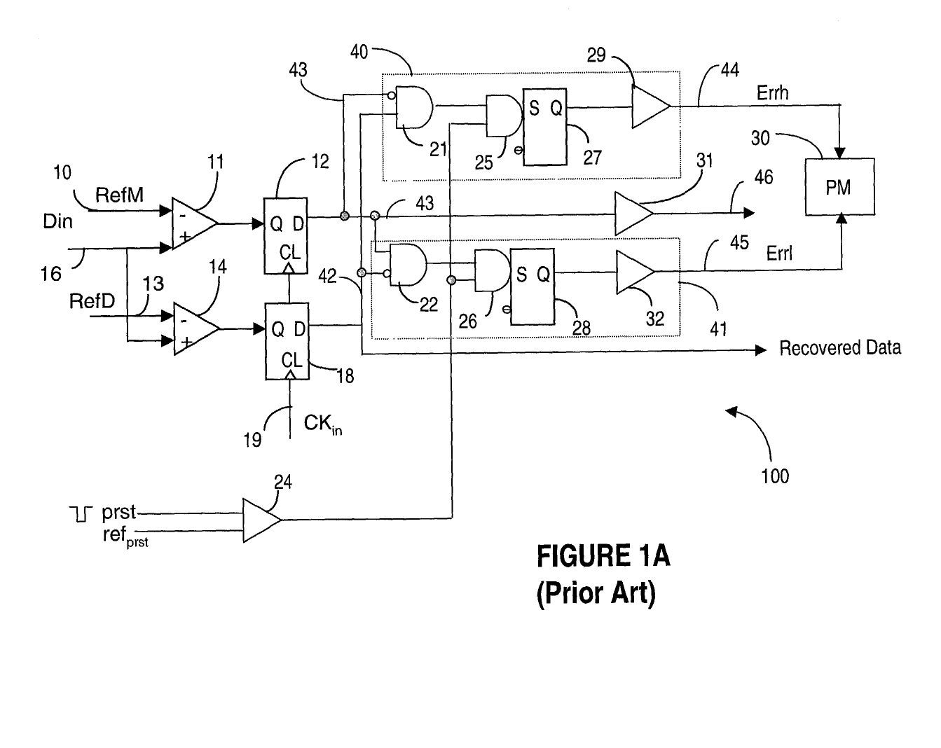

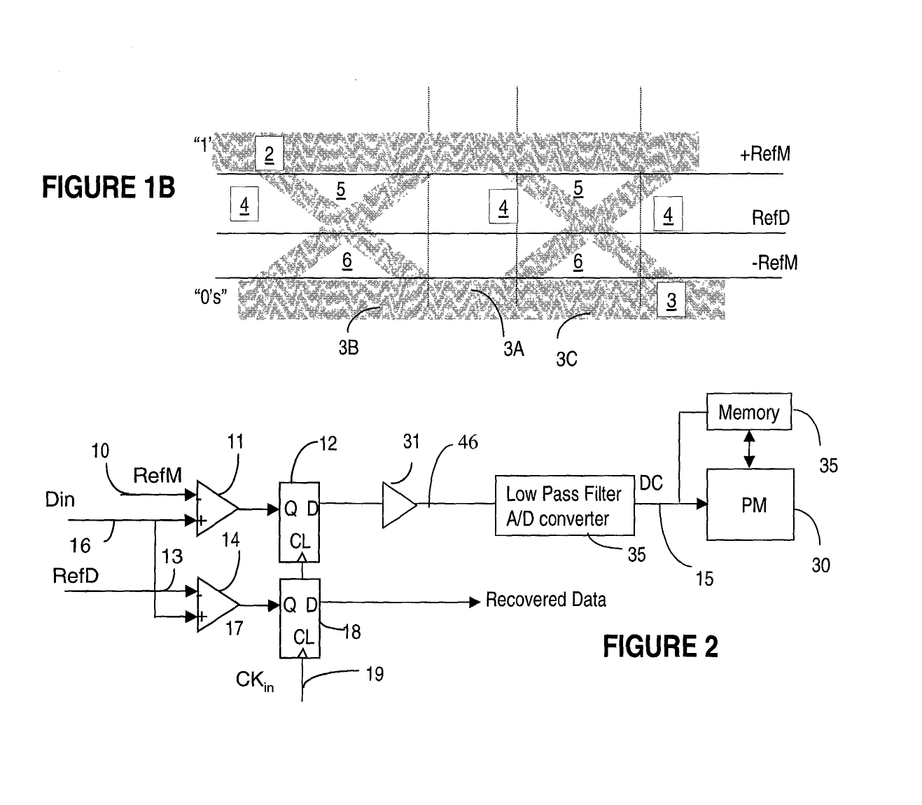

FIG. 1A shows the block diagram of a data decoder 100 used currently for regenerating data received over transmission lines, and FIG. 1B shows schematically an eye diagram for a recovered signal Dᵢₙ.

The term ‘recovered’ is used herein for the analog signal received over the transmission lines. In the case of an optical network, the optical signal is converted to the recovered signal using an optical-to-electrical converter, e.g. a PIN diode. The term ‘regenerated’ is used for the data obtained from the recovered signal, which should be identical to the data at the transmitter site. BER is a measure of the discrepancies between the transmitted and regenerated data.

Comparators 11 and 14 receive the analog signal Din from the optical-to-electrical detector (not shown) and decide the position of logical “1” and logical “0” bits. Dᵢₙ is applied on the non-inverting input of comparators 11 and 14, and a reference signal is applied on the respective negative input.

Comparator 11 uses a preset threshold Ref_{M}, and comparator 14 uses a decision threshold Ref_{D}. The decision threshold Ref_{D} is set by a performance monitor 30, according to the preset threshold Ref_{M} and the error information Errh, Errl.

The digital outputs of comparators 11 and 14 are retimed by retiming circuits 12 and 18 respectively, which are clocked at the binary data signal frequency by the recovered clock signal CKᵢₙ. Retiming circuits are preferably D-type flip-flops, the data input of which are supplied with the outputs of the comparators 11, 14, and the clock inputs CL of which are supplied by CKᵢₙ.

The regenerated data output signal is produced at the D output of the flip-flop 18, and is supplied to a data line 42, and also to a first input of a respective error counting circuit 40, 41. Pseudo-regenerated data 43 at the output of retiming circuit 12 is also applied to a second input of each error counting circuit 40 and 41. The outputs 44 and 45 of the error counting circuits, Errh and Errl are supplied to the performance monitor 30 for controlling the threshold levels RefD and RefM.

While operation of blocks 40 and 41 is irrelevant to this invention, it is to mention that output 44 gives the pseudo errors for the pseudoregenerated data in vicinity of “logical 1” (i.e. upper part of the eye in FIG. 1B, denoted with 2). Output 45 gives the pseudo errors for the pseudo-regenerated data in vicinity of “logical 0” (i.e. lower part of the eye in FIG. 1B, denoted with 3). This is obtained by applying the inverted value of the pseudo-regenerated data to AND gate 21 of error counting circuit 40, and applying the non-inverted value of the pseudo-regenerated data to AND gate 22 of error counting circuit 41. Thus, Errh and Errl correspond to a positive and a negative Ref_{M}, respectively on eye diagram of FIG. 1B.

The performance monitor 30 produces threshold Ref_{M} at such a voltage, that a predetermined BER on logic “1” bits of the data signal is produced in data at output 44 relative to the data on output 42, and detected by detection circuit 40. The predetermined BER for “logic 1's” and for “logic 0's” is for example in the range of 10-6.

The performance monitor 30 produces Ref_{D} in a certain relationship with Ref_{M}, so that it has an optimal value, i.e. is substantially in the middle of the eye opening (area 4), as shown in FIG. 1B. As such, Ref_{D} is positioned within the eye opening in an adaptive manner according to the current quality of the signal. By continuing measuring the pseudo-errors, the data regenerator adjusts itself to provide an optimal data signal in the presence of variations in signal intensity and degradation.

Also shown in FIG. 1A is an inverter 31 which inverts the pseudo-recovered data at the output of retiming circuit 12. The signal at output of inverter 31 is called domo and is currently used for testing purposes.

Decoder 100 works well for signals with a low BER. The eye diagram of the signals that can be recovered with the circuit 100 must be open, even if the opening of the eye is small. When the SNR (signal-to-noise ratio) is degraded in ultra long haul systems, the eye opening becomes unclear, and the decoder 100 may have problems in determining the optimal slicing level Ref_{D}.

FIG. 2 illustrates an improvement to decoder 100 according to the invention. The modification to the decoder 100 of FIG. 1A comprises a low-pass filter and analog-to-digital converter 35, connected to the ‘domo’ output 46. Filter 35 extracts the DC component of the ‘domo’ signal. As “domo” depends on Ref_{M} setting, the DC component is also dependent on the Ref_{M} setting.

The invention proposes to obtain on-line eye information, using the DC component 15 of ‘domo’ signal 46. For obtaining this information at a certain decision time, Ref_{M} is varied linearly, which brings about a variation of the DC component 15, which substantially follows-up the contour of eye of the information signal. The information is collected and used by the performance monitor 30 to further optimise the decision threshold Ref_{D}. The eye distribution can be extracted from the variation of Ref_{M} and the domo DC.

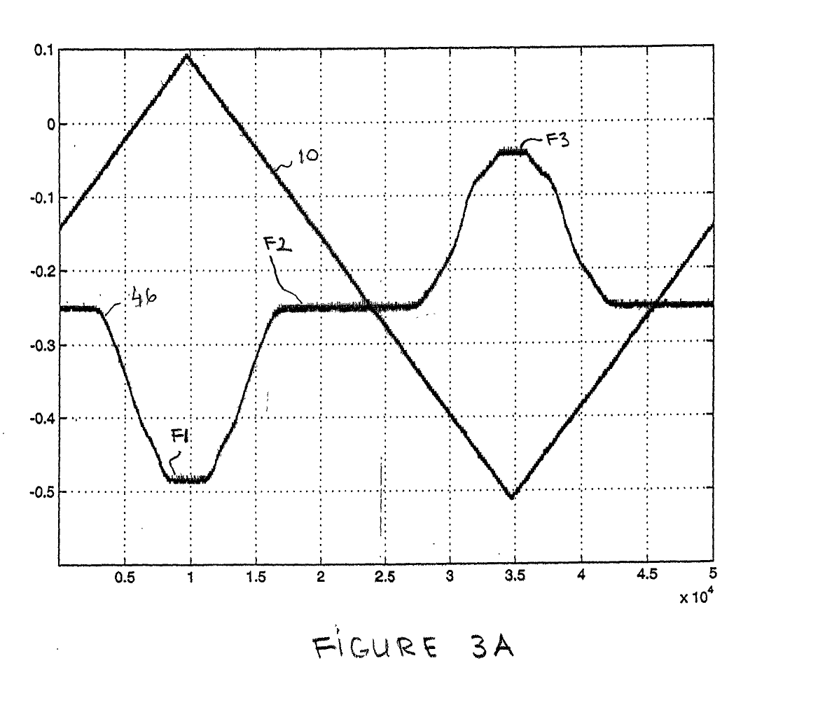

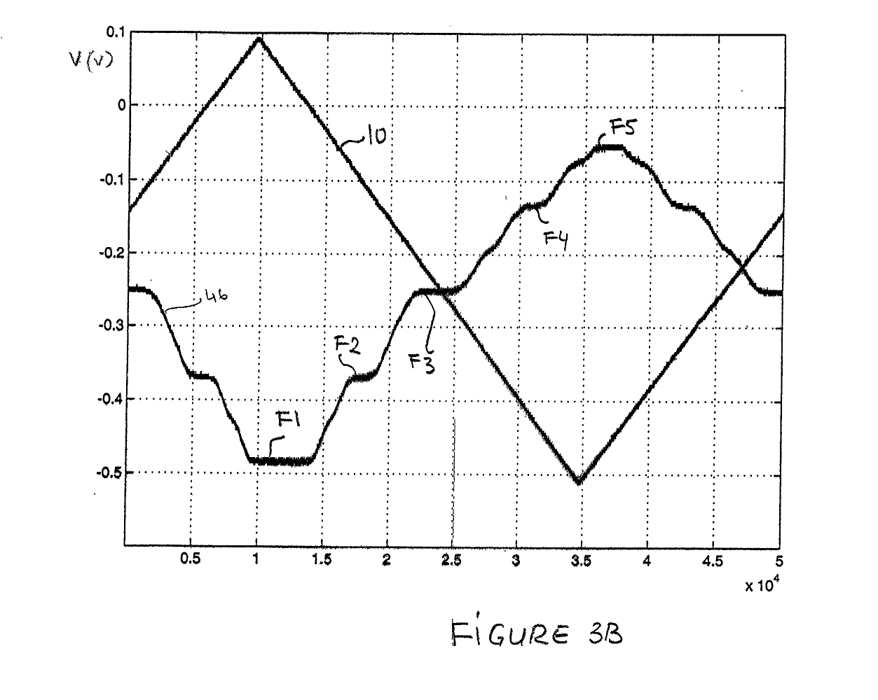

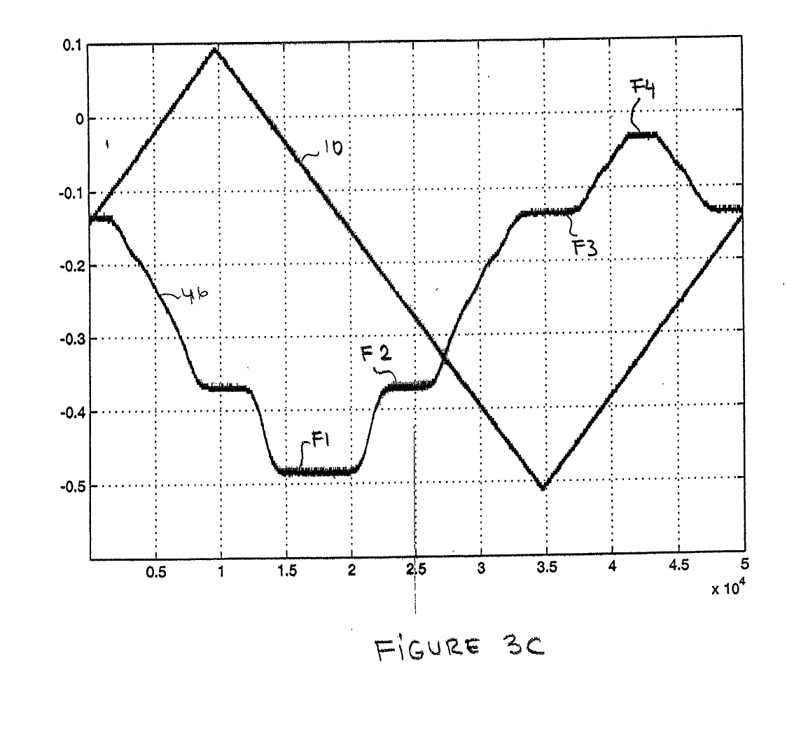

FIG. 3A shows a voltage—time graph 15 at domo output, for a linear variation of the Ref_{M} threshold. This graph could be construed as the histogram of the eye diagram at a particular timing. We will consider the variation of the Ref_{M} from the maximum to the minimum, as shown by reference numeral 10. The first flat portion F1 of the domo signal corresponds to the threshold Ref_{M} crossing the portion 2 of the eye. As the amplitude of the signal 15 is always under the threshold, all bits are interpreted as logical “0's”. As the threshold 10 decreases, a larger number of bits will cross it, and these bits will be construed by the decoder as logic “1's”. The second flat F2 occurs in the middle of the eye, denoted with reference numeral 4. This flat is rather wide, since the middle of the eye is ‘clean’ at the decision time 3A. As the threshold 10 decreases further, it reaches the area 3 of the eye, where all bits are interpreted as logic 1's” (all are above the threshold). This is shown by the third flat F3 on graph 15.

FIG. 3B shows the variation of the domo signal 15 for another decision time, indicated on FIG. 1B by reference numeral 3B. This graph has five flats F1-F5, corresponding to threshold 10 crossing in succession the eye in the areas denoted with 2, 5, 4, 6 and 3. It is to be noted that the flat portion F3 in the middle of the eye is rather narrower in comparison to that of F2 in FIG. 3A, since at decision time 3B the area 4 of the eye is minimal.

FIG. 3C shows the variation of the domo signal 15 for another decision time, indicated on FIG. 1B by reference numeral 3C. This graph has four flats F1-F4, corresponding to threshold 10 crossing in succession the eye in areas denoted with 2, 5, 6 and 3. It is to be noted that there is no flat portion in the middle of the eye at decision time 3C.

The performance monitor 30 can set the best data threshold based on the histogram information so collected. This histogram of the eye distribution information is obtained by the above illustration. Graphs 15 can be stored in a memory 35 and the decision can also be made based on historical data.

Similarly, the Errh and Errl pseudo error counts may also be used to set the Ref_{D} threshold.

While the invention has been described with reference to particular example embodiments, further modifications and improvements which will occur to those skilled in the art, may be made within the purview of the appended claims, without departing from the scope of the invention in its broader aspect.

I claim:

1. A device for determining an optimized decision threshold for a high speed, high rate data regenerator, comprising:
a first comparator and a first retiming circuit for comparing a recovered data signal with a preset threshold and providing a pseudo-data signal representative of said recovered data signal;
a second comparator and a second retiming circuit for comparing said recovered data signal with said optimized decision threshold and providing a regenerated data signal; and
a low pass filter for separating a DC component from said first signal and using said DC component to provide said optimized decision threshold.

2. A device as claimed in claim 1, wherein said preset threshold varies linearly from a high value to a low value to provide said DC component as a representative of the eye of said pseudo-data signal.

3. A device as claimed in claim 2, further comprising means for storing said DC component.

4. A method for determining an optimized decision threshold for a high speed, high rate data regenerator, comprising:
comparing and retiming a recovered data signal with a preset threshold, for providing a pseudo-data signal representative of said recovered data signal;
comparing and retiming said recovered data signal with said optimized decision threshold for providing a regenerated data signal;
filtering said pseudo-data signal for separating a DC component; and
monitoring said DC component to provide said optimized decision threshold.
